(19) United States
(12) Patent Application Publication
(10) Pub. No.: US 2010/0071573 A1
(43) Pub. Date: Mar. 25, 2010

(54) FOIL TRANSFER APPARATUS AND PROCESS

(76) Inventor: Christopher K. VanPelt, Nokomis, FL (US)

Correspondence Address: GIFFORD, KRASS, SPRINKLE,ANDERSON & CITKOWSKI, P.C, PO BOX 7021, TROY, MI, 48007-7021, US

(21) Appl. No.: 12/236,989

(22) Filed: Sep. 24, 2008

(51) Int. Cl. B41D 7/00; B44C 1/165

(52) U.S. Cl. 101/33; 156/233

(57) ABSTRACT

Method and apparatus for providing a printed substrate including at least a portion having a foil image adhered to the substrate which includes providing a heated thermal transfer plate and a makeready plate for supporting the substrate, providing means for moving a sheet of substrate one sheet at a time to a position between the thermal transfer plate and the makeready plate, means for moving foil to a position between the substrate and the thermal transfer plate and means for pressing the foil against the substrate to produce an image on the substrate.

### FIELD OF THE INVENTION

The present invention is directed to a foil transfer process and apparatus and more particularly to a process and an apparatus for utilizing toner and a heat and pressure process for adhering foil to paper to produce a foil printed product.

### BACKGROUND OF THE INVENTION

Processes for printing a substrate such as paper with foil are not new. U.S. Pat. No. 6,223,799 discloses a foil transfer apparatus for applying a foil to a toner printed unto paper or the like which includes a rotating impression cylinder and a rotating transfer cylinder. Heat is applied to portions of the transfer cylinder and the foil and the paper are web fed between the cylinders utilizing the heat and compression to transfer the metallic foil to the portions of the paper having the printed toner. Such systems require rather complicated timing means to rotate the cylinders at a speed which will properly position the foil over the individual sheets of paper. Further the heating means utilized in such systems are located outside of the cylinders and therefore do not efficiently apply heat to the paper and to the foil. Bleed-over of the foil or adhesion to the toner on toner images not intended to be foil printed is a common problem in systems of this type. With such systems it is difficult to provide a printed substrate which has normally printed images and foil images on the same sheet.

### SUMMARY OF THE INVENTION

The present invention provides apparatus for and a sheet feed process for printing foil on a substrate such as paper. While the process of the present invention can be utilized to print foils such as metallic, transparent or pigment foils onto a substrate such as paper the process will, for purposes of illustration, be described using metallic foil. The paper is preprinted to provide a layer of toner on the paper where metallic images are to be provided. The paper can also have toner in the form of printing which is not to have a foil layer attached. The sheets of paper are fed one sheet at a time to a transfer station. A foil of the make that will adhere to toner under heat and pressure is also fed to the transfer station preferably from a roll of foil above the sheet of preprinted paper. Heat and pressure are applied to the foil and paper at the transfer station by a thermal transfer plate which engages the foil as a makeready plate facing the thermal transfer plate is moved toward the thermal transfer plate. Means are located on the makeready plate to concentrate the heat and pressure on the foil and the paper in those areas where foil images are to adhere to toner. The printed paper with foil images is then moved from the transfer station and a new sheet of preprinted paper and a new portion of the foil are moved into position at the transfer station. The system of the present invention permits the printing of a substrate such as paper with normal print and foil printed images on the same sheet of paper.

### BRIEF DESCRIPTION OF THE DRAWINGS

A better understanding of a preferred embodiment of the present invention can be had by referring to the drawings wherein;

FIG. 1 is a schematic view of the printing method and apparatus of the present invention at a print ready position of the apparatus;

FIGS. 2A-2E are schematic views illustrating steps in the method of the present invention;

FIG. 3 is a fragmentary cross sectional view of a portion of the apparatus shown in FIG. 1;

FIG. 4 is fragmentary exploded view illustrating the relative positioning of the elements of the method during the process; and

FIG. 5 is an enlarged fragmentary cross sectional view of a portion of the structure shown in FIG. 3.

### DETAILED DESCRIPTION OF A PREFERRED EMBODIMENT

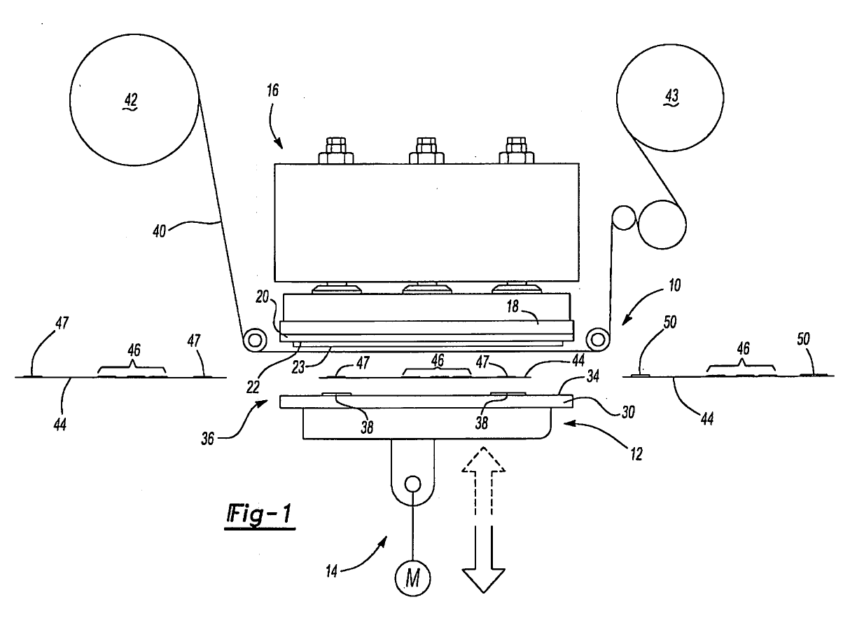

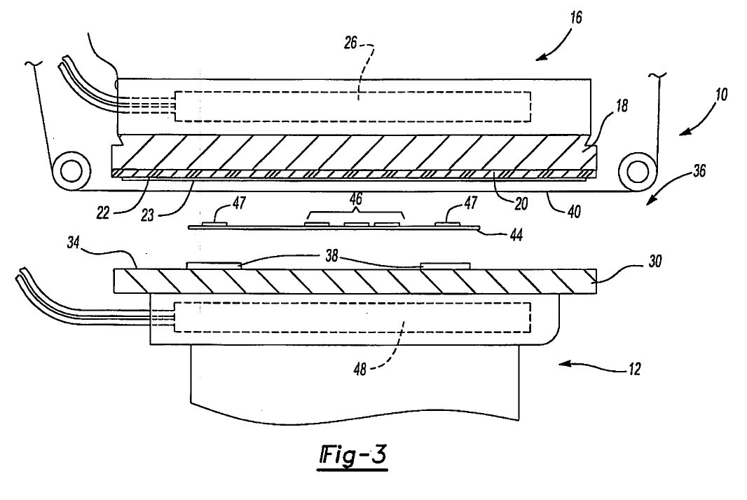

Now referring to the drawings for a description of a preferred embodiment of the present invention, FIG. 1 shows an apparatus diagrammatically as including a printing press 10 having a lower assembly 12 selectively vertically movable by a conventional drive 14. An upper assembly 16 of the printing press 10 is fixed and the lower assembly 12 is movable toward and away from the upper assembly 16. The upper assembly 16 includes a chase 18 and, as can best be seen in FIG. 3, a thermal transfer plate 20 is mounted to the chase 18 and includes a face 22. A coating 23 preferably formed of a silicone or similar material is provided on the face 22. A heater 26 is provided in the upper assembly 16 in a position to heat the thermal transfer plate 20.

Still referring to FIG. 3 the lower assembly 12 of the press 10 includes a makeready plate 30 having a face 34 opposite the face 22 on the thermal transfer plate 20. The space between the face 22 of thermal transfer plate 20 and the face 34 of the makeready plate 30 forms a transfer station generally indicated at 36. Blocks 38 are disposed on the face 34 of the makeready plate 38 in a spaced array for purposes that will be more clearly indicated as the description proceeds.

FIGS. 1 and 3 disclose the press 10 in a position prior to printing with the lower assembly 12 in the lowermost position and with the makeready plate 30 separated from the thermal transfer plate 20. As shown in FIG. 1 foil 40 is fed from a supply roll 42 through the space between the thermal transfer plate 20 and the makeready plate 30 to a take up roll 43. Paper 44 is fed one sheet at a time to the transfer station 36 to a position between the foil 40 and the face 34 of the makeready plate 30. The paper 44 is pre-printed to provide images in the form of toner 46 and 47. The toner images 47 are intended to be provided with a layer of foil 40 while the toner images 46 are to be left as normal printing. It is to be understood that the toner images 46 and 47 are formed in the same manner and the different numerals to distinguish them is simply to indicate which are to be coated with foil and which are not.

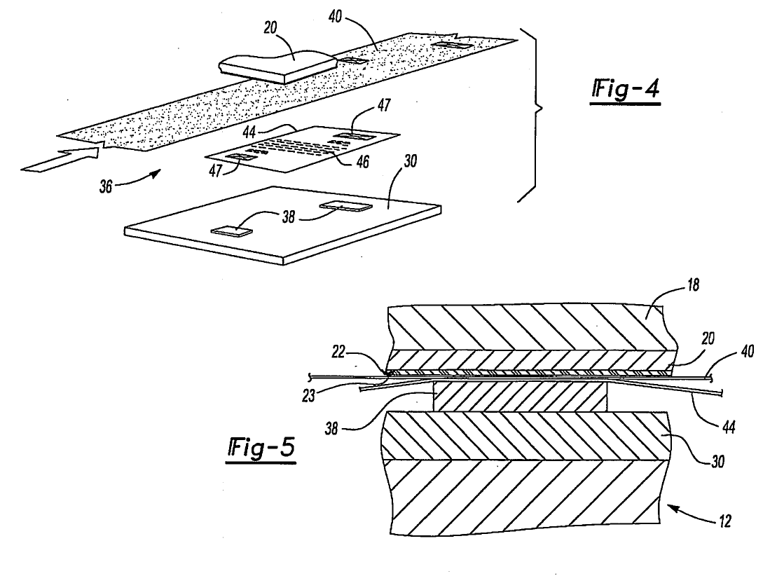

As can best be seen in FIG. 4 when a sheet of pre-printed paper 44 with toner images 46 and 47 is moved to the transfer station 36 atop the makeready plate 30 and unused foil 40 is disposed in the transfer station 36 above the paper 44, the drive 14 is actuated to move the makeready plate 30 toward the thermal transfer plate 20 to provide heat and compression to the foil 40 to adhere the foil 40 to the paper 44 in those areas with images formed by toner 47.

The blocks 38 as best shown in FIGS. 4 and 5 provide a means for fusing the metallic foil 40 to the toner image areas 47 on the sheets of paper 44 with a minimum of affect on other toner image 46. This is accomplished by cutting silicone, or a material with characteristics similar to silicone, and of the type used on the thermal transfer plate 20 to form the blocks 38 and placing the blocks 38 on the makeready plate 30 in positions below the toner images 47 so that when pressure is applied by moving the makeready plate 30 against the thermal transfer plate 20 pressure is only applied to the paper 44 in areas where the blocks 38 are compressed against the thermal transfer plate 20. This provides a layer of foil 40 which will adhere to the toner images 47 but because no compression is being applied to the paper 44 in the vicinity of the toner images 46 the printing represented by those images 46 will be left in their preprinted form. The result will ordinarily be a printed paper 44 in which only a selected portion of the printed images are covered with a coating of foil 40. Of course the process of the present invention can, when it is desired to do so, provide a foil coating over all of the toner images on the sheet of paper.

As best can be seen in FIG. 3 heating means 48 can be provided to heat the makeready plate 30 to provide additional heat to the paper 44 during impression. With such means there would be less heat loss from the thermal transfer plate 20 upon each impression.

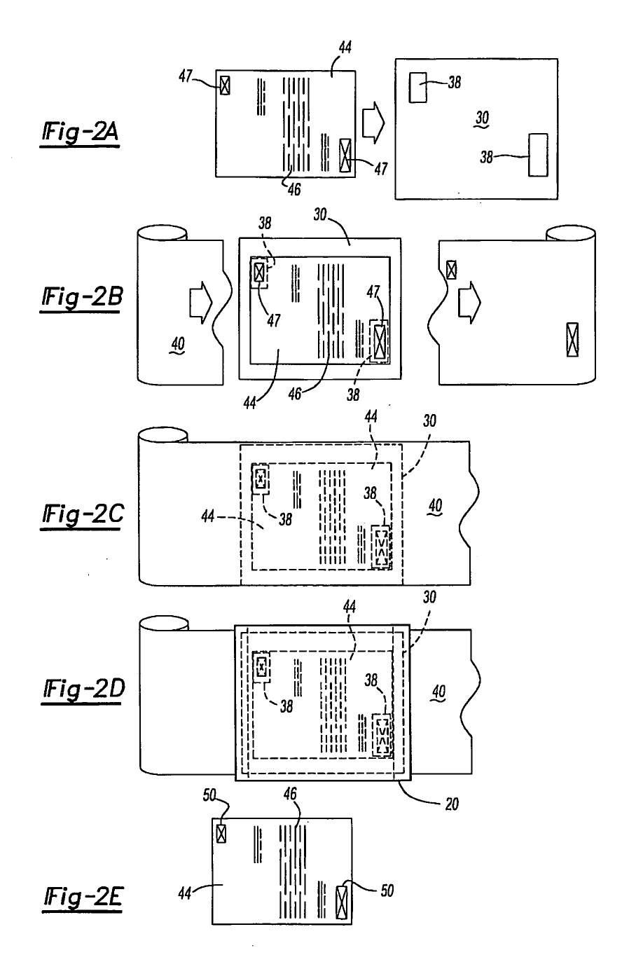

FIGS. 2A-2E illustrate the steps in the printing process of the present invention. FIG. 2A shows a sheet of paper 44 preprinted to provide toner images 47 in the locations on the paper 44 where the foil 40 is to be applied. The blocks 38, although shown as matching the toner 47 on the paper 44 in size and location, do not have to be as precise as shown. All that is necessary is that the blocks 38 be located to match up with the toner images 47 on the paper 44 but it is only necessary that the blocks 38 at least cover the area where the toner images 47 are located. The purpose of the blocks 38 is to concentrate the pressure on the foil 40 and the toner images 47 in the area of the toner images 47 so that when compression is applied upon closing of the makeready plate 30 against the thermal transfer plate 20 bleed-over is prevented between toner images 47 and 46. This insures that the layer of foil 40 will be applied to toner images 47 without coating those images 46 which are to be left as normal printing.

FIGS. 2B and 2C illustrates the paper 44 in a position on the makeready plate 30 with the foil 40 (FIG. 2C) overlying the paper 44. The blocks 38 are disposed on the makeready plate 30 beneath the toner image 47 which are to be coated with foil 40. The paper 44 also contains toner images 46 in the form of printing.

FIG. 2D illustrates the thermal transfer plate 20 applying heat and pressure to the foil 40 and the paper 44 and FIG. 2E illustrates the finished sheet of paper 44 with foil 40 covered toner images 50 and the normal toner images 46.

The toner images 46 and 47 are, of course, provided by a conventional printer which prints by applying toner images such as a laser printer or a copier which will apply toner 46 and 47 to the paper 44 in an ordinary printing process. All that is necessary is that a foil 40 be selected which will adhere to toner upon the application of heat and pressure. The printed paper 44 is then fed to the work station 36 (FIG. 1) one sheet at a time to have only toner images 47 coated with foil 40.

FIG. 4 illustrates the position when the makeready plate 30 and the thermal transfer plate 20 are separated to receive the printed paper 44 with toner 47 and blocks 38 in the locations where the foil coated images (not shown) are to be applied to the paper 44. The foil 40 has been moved to provide a clean portion to a position above the sheet of paper 44.

Using the process with a regular toner will provide a flat printed foil image. To obtain an embossed foil image a dimensional toner is used as a replacement for regular toner. One such dimensional toner found to be suitable for the process of the present method to produce an embossed image is sold by Kodak under the trademark “Dimensional Clear DryInk”.

It should be noted that although silicone has been selected to provide the coating 23 on the face 22 of the thermal transfer plate 20 and the blocks 38 other materials could be used to form the coating 23 and the blocks 38 as well. It is important, however, that the material selected provide cushioning of the paper 44 without unduly interfering with the transfer of heat from the heater 26. Foil 40 needs to be selected of the type that will adhere to toner upon the application of heat and compression. The toner images 46 and 47 are applied to the substrate in the form of printing from a printer which prints by applying a toner image.

The present invention provides an advantage over conventional foil stamping presses that require that a die be provided for each run. This makes short runs cost prohibitive. With the present invention the die is replaced by the thermal transfer plate 20 and the foil 40 is transferred to the paper 44 without the necessity of a die. Further the present invention provides a means of providing a foil layer either flat or embossed on selected images on a pre-printed substrate such as paper.

The method of the present invention can be utilized by converting conventional foil stamping presses by replacing the die ordinarily used in such presses with the thermal transfer plate 20. Such dies are commonly ¼ inch thick and for this reason it is preferred that the transfer thermal plate also be ¼ inch thick.

While the method of the present invention has been described as including a makeready plate as moving toward the thermal transfer plate it should be apparent that the thermal transfer plate could as well be movable toward the makeready plate or the plates could each be movable toward the other.

It should be apparent that a process and apparatus has been provided which makes it possible to economically create multiple copies of a sheet of paper 44 with either all of the print or portions of the print having a layer of foil 40. Further, by providing different sizes and a different number of blocks 38 and placing them differently on the makeready plate 30 different printed images can be layered. The ease at which the areas of printed paper 44 can be selected to be provided with a foil finish makes it economical to provide relatively short runs of different printed materials.

It should also be apparent to one with ordinary skill in the art that other modifications can be made to the invention as described without departing from the sprit of the invention or the scope of the appended claims.

1. A method for printing a foil image on a substrate comprising the steps of:
a. providing foil in a continuous roll
b. providing a substrate in sheet form with the substrate including means on one side to promote adhesion of the foil to the substrate upon the application of heat and pressure;
c. providing a makeready plate and means for feeding the substrate one sheet at a time to the makeready plate;
d. providing a heated heat transfer plate in a position above the makeready plate;
e. feeding the foil to a position between the heat transfer plate and the substrate; and
f. pressing the foil against the substrate to produce a foil image on the substrate.

2. The method as described in claim 1 and including the step of providing raised portions on the makeready plate which coincide with the portions of the foil to be adhered to the substrate so that upon pressing the foil against the substrate heat and pressure is applied to the foil at the raised portions.

3. The method as defined in claim 2 and said pressing step comprising moving the makeready plate toward the thermal transfer plate to press the foil against the substrate to provide for the adhesion of the foil over at least a portion of the substrate to provide a foil image thereon.

4. The method as defined in claim 1 and including the step of providing at least one toner image on that portion of the substrate that the foil is to be adhered to.

5. The method as defined in claim 3 and in which said toner is dimensional toner.

6. The method as defined in claim 4 and including feeding the sheets of substrate in cycles and to simultaneously advancing the foil to provide a new portion of the foil to a position above each sheet of substrate as the substrate is fed to a position to have the foil adhered to said toner image on said sheet of substrate.

7. The method as defined in claim 1 and including providing the face of the thermal transfer plate with a coating of silicone.

8. The method as defined in claim 2 and including said raised portions being silicone.

9. Apparatus for producing a foil image on a substrate comprising;
a) a first plate and a second plate disposed in a face to face position.
b) at least one of said plates being selectively heatable;
c) said substrate being selectively positioned between said plates;
d) said substrate having a face and at least one toner image formed on said face;
e) a foil and said foil being selectively positioned overlying said face of said substrate;
e) said plates being selectively operable to press said foil against said substrate to produce a foil image on said substrate where said toner mage is engaged by said foil.

10. The apparatus as defined in claim 9 and including a block disposed between said plate and said toner image on said substrate to produce compression between said foil and said toner image when said foil is pressed against substrate by said plates.

11. The apparatus as defined in claim 10 and in which said blocks are formed of silicone.
